(19) United States
(12) Patent Application Publication
(10) Pub. No.: US 2023/0136239 A1
(43) Pub. Date: May 4, 2023

(54) Support Rack Assembly

(71) Applicant: Peter Rennich, Ottawa (CA)

(72) Inventor: Peter Rennich, Ottawa (CA)

(21) Appl. No.: 17/516,808

(22) Filed: Nov. 2, 2021

(51) Int. Cl. A47J 43/18; A47J 37/04; A47J 37/07

(52) U.S. Cl. CPC A47J 43/18; A47J 37/049; A47J 37/0704; A47J 37/0786; A47J 2037/0795

(57) ABSTRACT

A support rack assembly for cooking food items in a cooking grill includes a pair of stands that is each positionable in a cooking grill. Each of the stands is comprised of a heat resistant material to resist being damaged by heat of the cooking grill. Each of the stands has a plurality of support points that are disposed on the stands. A plurality of bars is each insertable through a respective one of the support points on each of the stands such that each of the bars is elevated above the cooking grill. A plurality of hooks is each of the hooks is suspendable from a respective one of the bars. Furthermore, each of the hooks can penetrate a food item thereby facilitating the food item to be suspended in the cooking grill for cooking the food item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to support rack devices and more particularly pertains to a new support rack device for cooking food items in a cooking grill. The device includes a pair of stands and a plurality of washers that are each attached to a respective one of the stands. The device includes a plurality of bars that are each extendable through respective washers such that the bars extend between the pair stands. The stands are positionable on a cooking grill such that the bars are elevated over the cooking grill. A plurality of hooks is provided which can be extended through a food item and for suspending the food item from the bars.

### (2) Description of Related Art Including Information Disclosed Under 37 CFR 1.97 and 1.98

The prior art relates to support rack devices including a cylindrical smoker which includes a plurality of hooks for suspending a food item for cooking. The prior art discloses a wire frame that is positionable in a frying pan for supporting a food item in an upright orientation in the frying pan. The prior art discloses a support frame with a plurality of notches and a plurality of skewers that are insertable through a food item and which can be positioned in respective notches for suspending the food item in a cooking grill. The prior art discloses a cooking stand which includes a horizontal member which has a slidably adjustable length and a plurality of hooks which can be suspended from the horizontal member for suspending food items over a cooking grill.

### BRIEF SUMMARY OF THE INVENTION

An embodiment of the disclosure meets the needs presented above by generally comprising a pair of stands that is each positionable in a cooking grill. Each of the stands is comprised of a heat resistant material to resist being damaged by heat of the cooking grill. Each of the stands has a plurality of support points that are disposed on the stands. A plurality of bars is each insertable through a respective one of the support points on each of the stands such that each of the bars is elevated above the cooking grill. A plurality of hooks is each of the hooks is suspendable from a respective one of the bars. Furthermore, each of the hooks can penetrate a food item thereby facilitating the food item to be suspended in the cooking grill for cooking the food item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a support rack assembly according to an embodiment of the disclosure.

FIG. 2 is a front view of an embodiment of the disclosure.

FIG. 3 is a back view of an embodiment of the disclosure showing a plurality of bars being slidably integrated into a pair of stands.

FIG. 4 is a bottom view of an embodiment of the disclosure showing a plurality of bars being slidably integrated into a pair of stands.

FIG. 5 is a perspective in-use view of an embodiment of the disclosure.

### DETAILED DESCRIPTION OF THE INVENTION

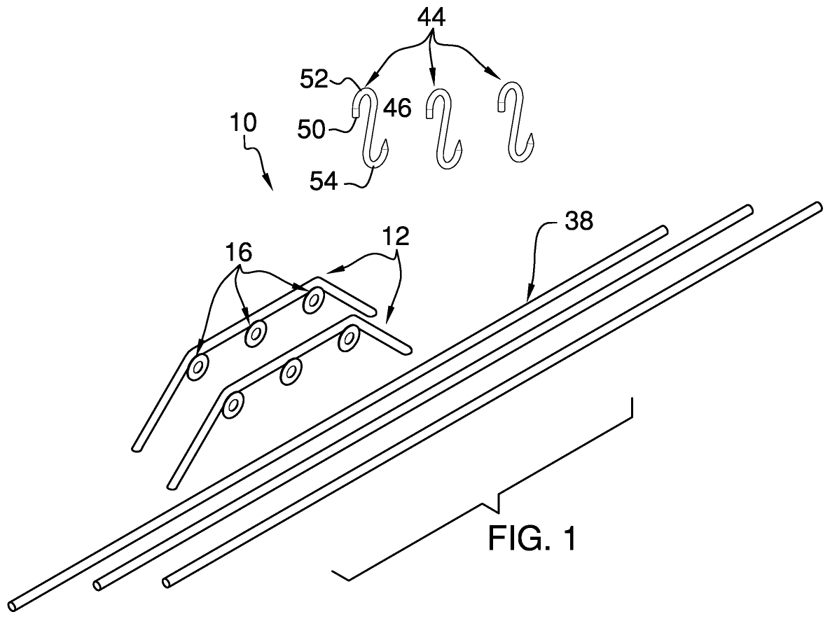

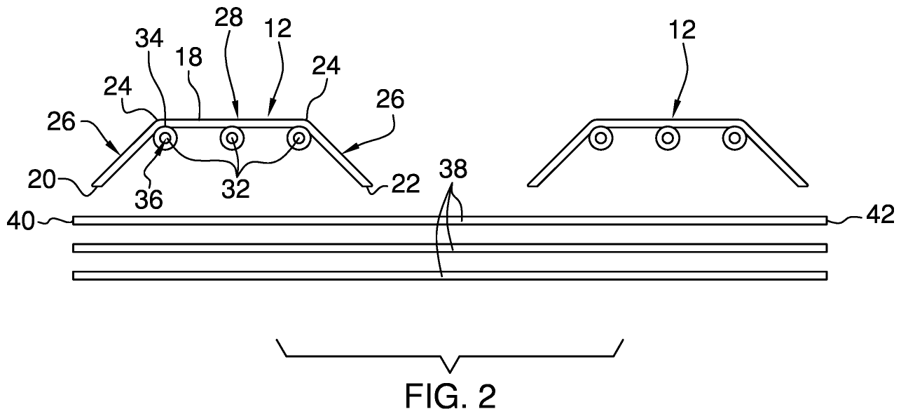

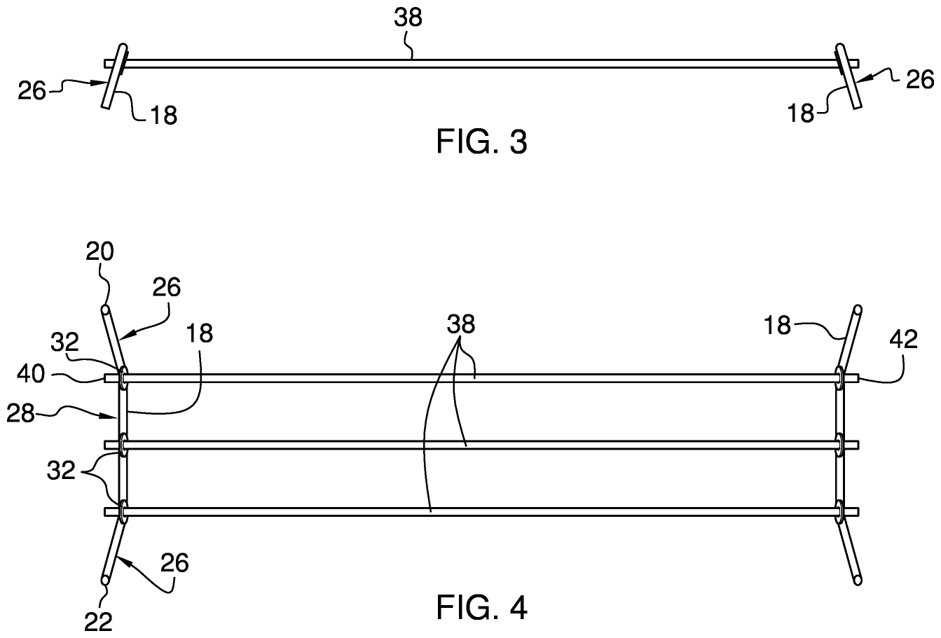

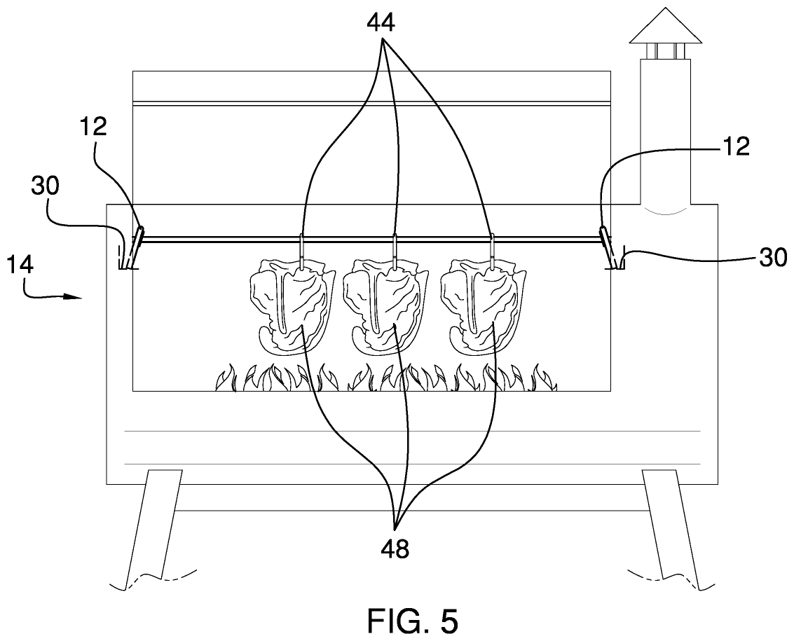

With reference now to the drawings, and in particular to FIGS. 1 through 5 thereof, a new support rack device embodying the principles and concepts of an embodiment of the disclosure and generally designated by the reference numeral 10 will be described.

As best illustrated in FIGS. 1 through 5, the support rack assembly 10 generally comprises a pair of stands 12 that is each of the stands 12 is positionable in a cooking grill 14. Each of the stands 12 can be positioned on opposite ends of the cooking grill 14 with respect to each other. The cooking grill 14 may comprise a charcoal grill, a smoker, a gas grill or any other type of cooking grill that employs a heat source for cooking food. Each of the stands 12 is comprised of a heat resistant material to resist being damaged by heat of the cooking grill 14. Additionally, each of the stands 12 has a plurality of support points 16 that are disposed on the stands 12.

Each of the stands 12 comprises a member 18 that has a first end 20 and a second end 22, and the member 18 is elongated between the first end 20 and the second end 22. The member 18 has a pair of bends 24 that is each integrated in the member 18. Each of the bends 24 is spaced from a respective one of the first end 20 and the second end 22 to define a pair of outward portions 26 of the member 18 that are oriented at an obtuse angle with a central portion 28 of the member 18. Furthermore, each of the first end 20 and the second end 22 is associated with a respective one of the outward portions 26. Each of the first end 20 and the second end 22 rests on a support 30 in the cooking grill 14 such that the central portion 28 of the member 18 is horizontally oriented.

Each of the stands 12 includes a plurality of washers 32 that each has a perimeter edge 34 and a hole 36. The perimeter edge 34 of each of the washers 32 is coupled to the central portion 28 of the member 18 having each of the washers 32 extending downwardly from the central portion 28 such that each of the washers 32 defines a respective one of the support points 16. Each of the washers 32 is oriented to lay on a plane that is oriented parallel to a lengthwise axis of the central portion 28. Moreover, the washers 32 are spaced apart from each other and are distributed along a full length of the central portion 28.

A plurality of bars 38 is provided and each of the bars 38 is insertable through a respective one of the support 30 points on each of the stands 12 such that each of the bars 38 is elevated above the cooking grill 14. Moreover, each of the bars 38 is oriented to extend along a horizontal axis when the bars 38 are inserted through the respective support 30 points. Each of the bars 38 has a primary end 40 and a secondary end 42, and each of the bars 38 is elongated between the primary end 40 and the secondary end 42. Each of the primary end 40 and the secondary end 42 is insertable through the hole 36 in a respective one of the washers 32 on the central portion 28 of each of the stands 12. Additionally, each of the bars 38 is comprised of a heat resistant material to resist being damaged by heat of the cooking grill 14.

A plurality of hooks 44 is provided and each of the hooks 44 is suspendable from a respective one of the bars 38. Each of the hooks 44 has a pointed end 46 which can penetrate a food item 48 thereby facilitating the food item 48 to be suspended in the cooking grill 14 for cooking the food item 48. The food item 48 may be a meat product, such as whole chicken or a rack of ribs, a vegetable product or any other type of food item that is commonly cooked in a cooking grill. Each of the hooks 44 has a distal end 50 with respect to the pointed end 46 and each of the hooks 44 has a first curve 52 that is integrated into the hooks 44. The first curve 52 extends from the distal end 50 of a respective hook 44 toward the pointed end 46 of the respective hook 40.

Each of the hooks 44 has a second curve 54 that is integrated into the hooks 44. The second curve 54 extends from the pointed end 46 of a respective hook 44 toward the first curve 52 of the respective hook. Additionally, the second curve 54 curves in an opposite direction with respect to the first curve 52 such that the distal end 50 is directed toward the pointed end 46. The first curve 52 of each of the hooks 44 rests on the respective bar 38 having the hooks 44 extending downwardly from the respective bar 38 and having the pointed end 46 being directed upwardly toward the respective bar 38. In this way the second curve 54 on each of the hooks 44 can support 30 the food item 48 when the pointed end 46 is extended through the food item 48. Additionally, the pointed end 46 on each of the hooks 44 tapers to a point.

In use, each of the stands 12 is positioned at a preferred location on the cooking grill 14 and one or more of the bars 38, depending on a user's preference, are extended through respective washers 32 on the stands 12. In this way the one or more bars 38 are supported above the cooking grill 14 in a horizontal orientation. The pointed end 46 on a chosen number of the hooks 44 is inserted through the food item 48, depending on the number of food items that are being cooked in the cooking grill 14. Each of the chosen number of hooks 44 is suspended on a respective bar 38. In this way the food item 48s can be supported above the cooking grill 14 thereby facilitating the food items 48 to be strategically positioned for optimal cooking heat. Thus, the food items 48 can be cooked more slowly than might otherwise be possible.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A support rack assembly for suspending food in a cooking grill, said assembly comprising:
a pair of stands, each of said stands being positionable in a cooking grill having each of said stands being positioned on opposite ends of said cooking grill with respect to each other, each of said stands being comprised of a heat resistant material wherein each of said stands is configured to resist being damaged by heat of the cooking grill, each of said stands having a plurality of support points being disposed on said stands;
a plurality of bars, each of said bars being insertable through a respective one of said support points on each of said stands such that each of said bars is elevated above the cooking grill, each of said bars being oriented to extend along a horizontal axis when said bars are inserted through said respective support points; and
a plurality of hooks, each of said hooks being suspendable from a respective one of said bars, each of said hooks having a pointed end wherein said pointed end on each of said hooks is configured to penetrate a food item thereby facilitating the food item to be suspended in the cooking grill for cooking the food item.

2. The assembly according to claim 1, wherein each of said stands comprises a member having a first end and a second end, said member being elongated between said first end and said second end, said member having a pair of bends each being integrated in said member, each of said bends being spaced from a respective one of said first end and said second end to define a pair of outward portions of said member being oriented at an obtuse angle with a central portion of said member.

3. The assembly according to claim 2, wherein each of said first end and said second end is associated with a respective one of said outward portions, each of said first end and said second end resting on a support in the cooking grill such that said central portion of said member is horizontally oriented.

4. The assembly according to claim 2, wherein each of said stands includes a plurality of washers, each of said washers having a perimeter edge and a hole, said perimeter edge of each of said washers being coupled to said central portion of said member having each of said washers extending downwardly from said central portion such that each of said washers defines a respective one of said support points.

5. The assembly according to claim 4, wherein each of said washers is oriented to lie on a plane being oriented parallel to a lengthwise axis of said central portion, said washers being spaced apart from each other and being distributed along a full length of said central portion.

6. The assembly according to claim 4, wherein each of said bars has a primary end and a secondary end, each of said bars being elongated between said primary end and said secondary end, each of said primary end and said secondary end being insertable through said hole in a respective one of said washers on said central portion of each of said stands.

7. The assembly according to claim 1, wherein each of said hooks has a distal end with respect to said pointed end, each of said hooks having a first curve being integrated into said hooks, said first curve extending from said distal end of a respective hook toward said pointed end of said respective hook, each of said hooks having a second curve being integrated into said hooks, said second curve extending from said pointed end of a respective hook toward said first curve of said respective hook, said second curve curving in an opposite direction with respect to said first curve such that said distal end is directed toward said pointed end.

8. The assembly according to claim 7, wherein said first curve of each of said hooks rests on said respective bar having said hooks extending downwardly from said bar and having said pointed end being directed upwardly toward said bar wherein said second curve on each of said hooks is configured to support the food item when said pointed end is extended through the food item, said pointed end on each of said hooks tapering to a point.

9. A support rack assembly for suspending food in a cooking grill, said assembly comprising:
a pair of stands, each of said stands being positionable in a cooking grill having each of said stands being positioned on opposite ends of said cooking grill with respect to each other, each of said stands being comprised of a heat resistant material wherein each of said stands is configured to resist being damaged by heat of the cooking grill, each of said stands having a plurality of support points being disposed on said stands, each of said stands comprising:
a member having a first end and a second end, said member being elongated between said first end and said second end, said member having a pair of bends each being integrated in said member, each of said bends being spaced from a respective one of said first end and said second end to define a pair of outward portions of said member being oriented at an obtuse angle with a central portion of said member, each of said first end and said second end being associated with a respective one of said outward portions, each of said first end and said second end resting on a support in the cooking grill such that said central portion of said member is horizontally oriented; and
a plurality of washers, each of said washers having a perimeter edge and a hole, said perimeter edge of each of said washers being coupled to said central portion of said member having each of said washers extending downwardly from said central portion such that each of said washers defines a respective one of said support points, each of said washers being oriented to lie on a plane being oriented parallel to a lengthwise axis of said central portion, said washers being spaced apart from each other and being distributed along a full length of said central portion;
a plurality of bars, each of said bars being insertable through a respective one of said support points on each of said stands such that each of said bars is elevated above the cooking grill, each of said bars being oriented to extend along a horizontal axis when said bars are inserted through said respective support points, each of said bars having a primary end and a secondary end, each of said bars being elongated between said primary end and said secondary end, each of said primary end and said secondary end being insertable through said hole in a respective one of said washers on said central portion of each of said stands; and
a plurality of hooks, each of said hooks being suspendable from a respective one of said bars, each of said hooks having a pointed end wherein said pointed end on each of said hooks is configured to penetrate a food item thereby facilitating the food item to be suspended in the cooking grill for cooking the food item, each of said hooks having a distal end with respect to said pointed end, each of said hooks having a first curve being integrated into said hooks, said first curve extending from said distal end of a respective hook toward said pointed end of said respective hook, each of said hooks having a second curve being integrated into said hooks, said second curve extending from said pointed end of a respective hook toward said first curve of said respective hook, said second curve curving in an opposite direction with respect to said first curve such that said distal end is directed toward said pointed end, said first curve of each of said hooks resting on said respective bar having said hooks extending downwardly from said bar and having said pointed end being directed upwardly toward said bar wherein said second curve on each of said hooks is configured to support the food item when said pointed end is extended through the food item, said pointed end on each of said hooks tapering to a point.

10. A support rack system for suspending food in a cooking grill, said system comprising:
a cooking grill having a having a pair of supports each being integrated into opposite ends of said cooking grill;
a pair of stands, each of said stands being positionable in said cooking grill having each of said stands being positioned on opposite ends of said cooking grill with respect to each other, each of said stands being comprised of a heat resistant material wherein each of said stands is configured to resist being damaged by heat of said cooking grill, each of said stands having a plurality of support points being disposed on said stands, each of said stands comprising:
a member having a first end and a second end, said member being elongated between said first end and said second end, said member having a pair of bends each being integrated in said member, each of said bends being spaced from a respective one of said first end and said second end to define a pair of outward portions of said member being oriented at an obtuse angle with a central portion of said member, each of said first end and said second end being associated with a respective one of said outward portions, each of said first end and said second end resting on a respective one of said supports in said cooking grill such that said central portion of said member is horizontally oriented; and
a plurality of washers, each of said washers having a perimeter edge and a hole, said perimeter edge of each of said washers being coupled to said central portion of said member having each of said washers extending downwardly from said central portion such that each of said washers defines a respective one of said support points, each of said washers being oriented to lie on a plane being oriented parallel to a lengthwise axis of said central portion, said washers being spaced apart from each other and being distributed along a full length of said central portion;
a plurality of bars, each of said bars being insertable through a respective one of said support points on each of said stands such that each of said bars is elevated above said cooking grill, each of said bars being oriented to extend along a horizontal axis when said bars are inserted through said respective support points, each of said bars having a primary end and a secondary end, each of said bars being elongated between said primary end and said secondary end, each of said primary end and said secondary end being insertable through said hole in a respective one of said washers on said central portion of each of said stands; and
a plurality of hooks, each of said hooks being suspendable from a respective one of said bars, each of said hooks having a pointed end wherein said pointed end on each of said hooks is configured to penetrate a food item thereby facilitating the food item to be suspended in said cooking grill for cooking the food item, each of said hooks having a distal end with respect to said pointed end, each of said hooks having a first curve being integrated into said hooks, said first curve extending from said distal end of a respective hook toward said pointed end of said respective hook, each of said hooks having a second curve being integrated into said hooks, said second curve extending from said pointed end of a respective hook toward said first curve of said respective hook, said second curve curving in an opposite direction with respect to said first curve such that said distal end is directed toward said pointed end, said first curve of each of said hooks resting on said respective bar having said hooks extending downwardly from said bar and having said pointed end being directed upwardly toward said bar wherein said second curve on each of said hooks is configured to support the food item when said pointed end is extended through the food item, said pointed end on each of said hooks tapering to a point.
